(19) United States
(12) Patent Application Publication
(10) Pub. No.: US 2018/0132689 A1
(43) Pub. Date: May 17, 2018

(54) Chainmail Sponge

(71) Applicant: N.A.F. Sales Inc., Northvale, NJ (US)

(72) Inventors: Chaim H. Neiman, Monsey, NY (US); Nuchem A. Fried, Monsey, NY (US)

(73) Assignee: N.A.F. Sales Inc., Northvale, NJ (US)

(21) Appl. No.: 15/353,335

(22) Filed: Nov. 16, 2016

(51) Int. Cl. A47L 13/07; A47L 17/08; B25G 3/36

(52) U.S. Cl. CPC A47L 13/07; B25G 3/36; A47L 17/08

(57) ABSTRACT

The present invention discloses a cleaning tool. The cleaning tool includes a chainmail outer shell and a sponge inner core. The outer shell is formed of chainmail material and is formed to lift and stubborn grime. The inner sponge core is formed to absorb liquid, such as water, and hold cleaning detergent.

### FIELD OF INVENTION

The present invention relates to a sponge for cleaning. More particularly, the present invention pertains to a sponge enclosed in chainmail material for use in cleaning.

### BACKGROUND OF THE INVENTION

Conventional dish care products, kitchen cleaners, and cleansing products generally, usually rely on a water absorbent cleansing device. In many instances, an individual wishing to clean their kitchen utensils, such as pots, pans, or cutlery (hereinafter also referred to as “kitchen utensils”), as well as surfaces such as countertops, ovens, stovetops, and even toilets (hereinafter also referred to as “surfaces”) utilizes a sponge with water and a cleansing product, such as soap/detergent.

A conventional soap and sponge combination, though effective at reducing or eliminating germs, often times is ineffective at removing tough, stuck-on dirt, grime, particles or food.

In scenarios where the soap and sponge combination is not effective, a second tool, such as a scouring pad, often made from steel wool, must be used to remove the dirt deposits. However, these scouring pads are rough and difficult to grip. Additionally, such pads do not hold and store large amounts of water and detergent to increase the cleansing and anti-microbial cleansing products.

Another alternative, for tough stuck-on dirt deposits, is a chainmail pad. Such sponges are hollow on the interior, and utilize thin metal to lift dirt. However, chainmail, due to its thinned nature, is difficult to grip and hold. Additionally, as it is metal and formed of small sharp edges, the chainmail cannot hold and/or absorb liquid or cleansing detergent.

Therefore, both scouring pads and chainmail, while effective for removing tough stuck-on dirt deposits, are difficult to hold due to their compressed nature. Furthermore, both scouring pads and chainmail are unable to be used to clean the actual surfaces and kitchen utensils, because they cannot hold water and detergent. Thus, both scouring pads and chainmail must be used in conjunction with, but separately from, one another, increasing the complexity and amount of time to clean surfaces.

It would be desirable, therefore, to provide a cleaning tool that includes both dirt-lifting properties for removing tough stuck-on dirt, in addition to the ability to clean, using water and dish detergent. It would be further desirable to provide a cleaning tool that provides these features in the same tool. It would be yet further desirable to provide a cleaning tool that allows for better gripping by increasing the grasping surface of the cleaning tool.

### SUMMARY

The cleaning tool of the present invention includes a chainmail sponge. The chainmail sponge includes an outer shell of chainmail material for lifting dirt and stuck-on grime. The cleaning tool further includes an inner sponge core. The inner sponge core is sufficiently porous to absorb water and cleaning detergent.

The cleaning tool may provide for increased gripping and grasping by providing a resilient shaped sponge core that allows the user to hold the tool and scrub. The tool is sufficiently formed such that the inner sponge core forms a shape, and the outer shell of chainmail drapes around the shape. This provides a tool with a formed shape that is not flat. The cleaning tool further provides for the capability of combining dirt-lifting and scrubbing properties with the ability for antimicrobial cleansing using detergent and water.

The cleaning tool may also include a handle. The handle may be removably or permanently connected to the cleaning tool. The handle may allow for even further increased gripping and grasping surface.

### BRIEF DESCRIPTION OF THE DRAWINGS

FIG. 1 illustrates a perspective view of an exemplary embodiment of the invention.

FIG. 2 illustrates a side view of the exemplary embodiment of the invention.

FIG. 3 illustrates a top view of the exemplary embodiment of the invention.

FIG. 4 illustrates a bottom view of the exemplary embodiment of the invention.

FIG. 5 illustrates close-up view of the exemplary embodiment of the invention.

FIG. 6 illustrates an exploded view of the exemplary embodiment of the invention.

FIG. 7 illustrates another exemplary embodiment of the invention.

FIGS. 8-9 illustrate another exemplary embodiment of the invention.

FIGS. 10-14 illustrate another exemplary embodiment of the invention.

FIGS. 15-18 illustrate another exemplary embodiment of the invention.

FIGS. 19-24 illustrate another exemplary embodiment of the invention.

FIGS. 25-29 illustrate another exemplary embodiment of the invention.

FIGS. 30-34 illustrate another exemplary embodiment of the invention.

FIGS. 35-40 illustrate another exemplary embodiment of the invention.

FIGS. 41-47 illustrate additional embodiments of the invention.

FIGS. 48-50 illustrate another exemplary embodiment of the invention.

FIGS. 51-55 illustrate another exemplary embodiment of the invention.

### DETAILED DESCRIPTION OF THE INVENTION

Although the following detailed description contains many specific details for the purpose of illustration of the invention, anyone of ordinary skill in the art will appreciate that many variations and alterations to the following details are within the scope of the invention. Accordingly, the following embodiments of the invention are set forth without imposing limitations on the claimed invention.

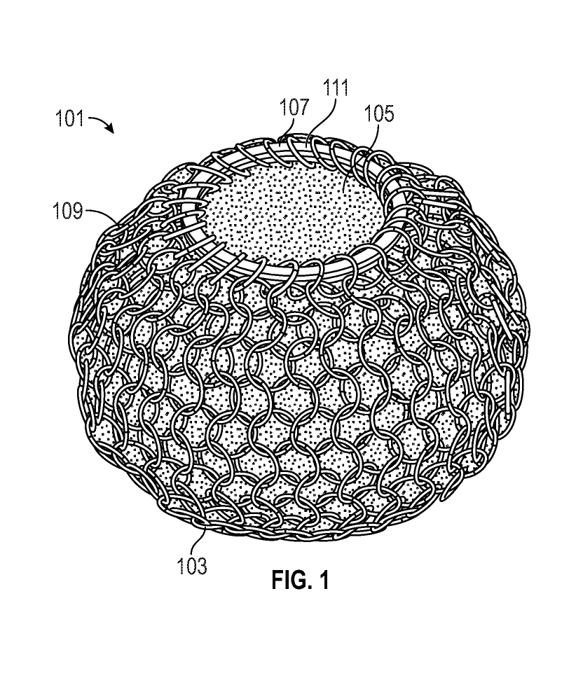

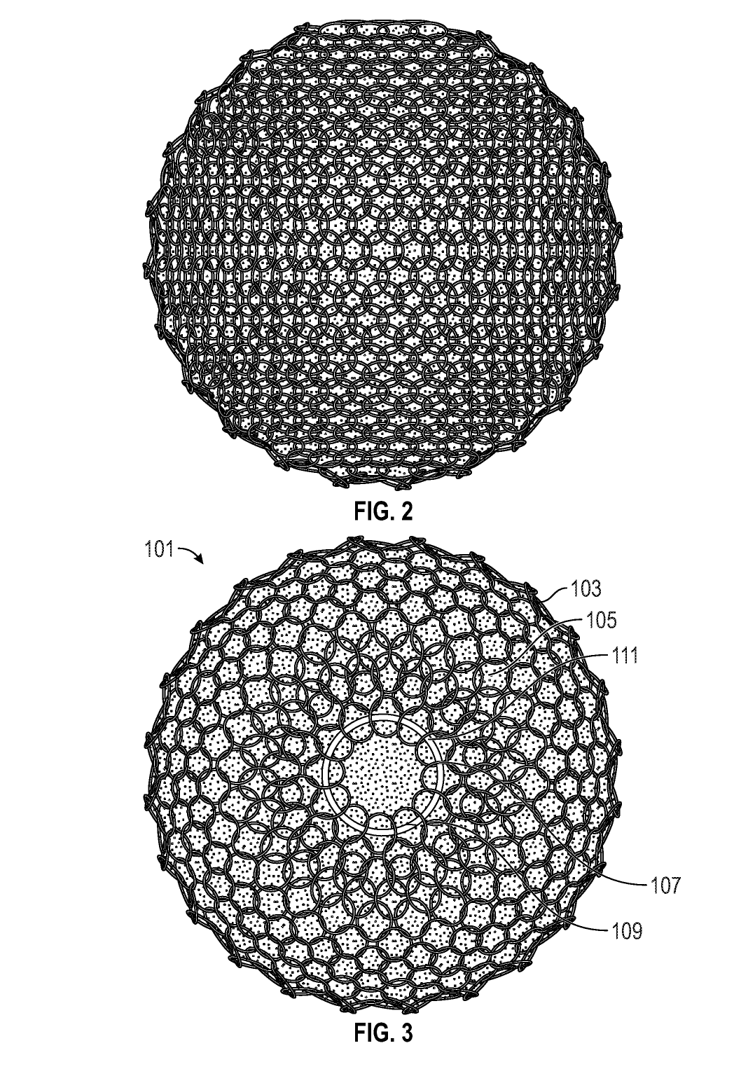

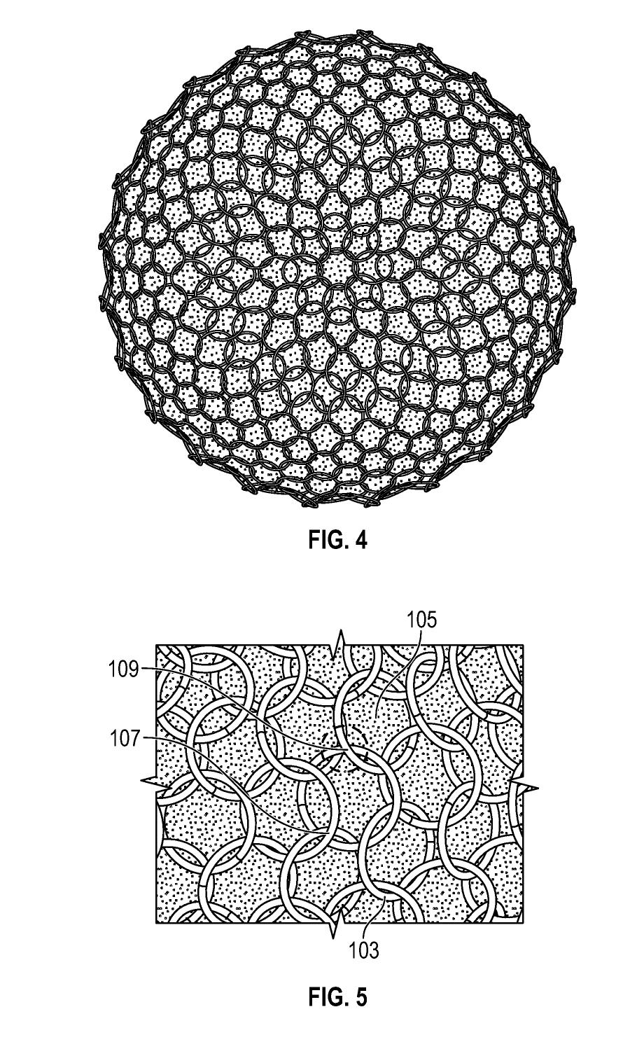

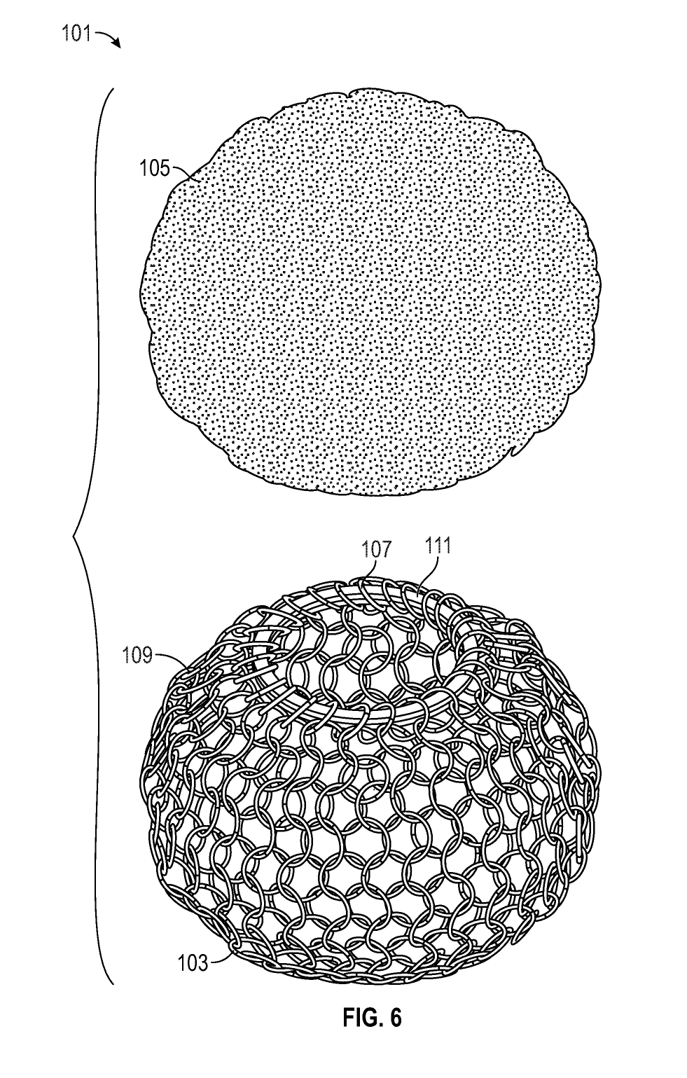

Referring now to FIG. 1, illustrated is a view of the inventive chainmail sponge 101. The chainmail sponge 101 (also referred to as the “tool”) includes a chainmail outer shell 103, and an inner sponge core 105.

Inner sponge core 105 may be any suitable sponge, sponge-like or liquid-absorbent material. In accordance with the invention, the sponge core 105 is formed to the same shape contour of the outer shell 103, thereby increasing the surface area of the cleansing surface, and maximizing the symbiotic relationship between the two cleansing products. The sponge core 105 may be formed of a sponge material. Sponge material may include a porous, non-rigid absorbent material. In an embodiment, the sponge material may be capable of holding weight of water greater than its own weight. In accordance with the invention, the sponge is a light, soft porous substance formed of synthetic or natural materials, and suitable for absorbing liquid. Thus, the inner sponge core 105 is formed of sponge material, which is able to take and hold liquid, and is usable for washing and cleaning.

In one embodiment, the sponge core 105 may be formed of cellulose, such as wood pulp. The sponge may be densely porous. In another embodiment, sponge core 105 may be porous to absorb liquid and cleansing detergent or soap, but may be sufficiently smooth to prevent particles, such as food or dirt, from being trapped within the pores. Thus, in accordance with the invention, the sponge core 105 may be smoothed with porous materials sufficiently small to only hold liquid and detergent.

In one embodiment of the invention, sponge core 105 may be formed from a soft material, such as microfiber. In another embodiment, the sponge core 105 is formed from cellulose wood fiber, foam plastic polymer, PVA, polyester, or any other suitable material.

Outer shell 103 is a ringed mesh pad formed of chainmail. Outer shell 103 is specifically formed with scouring capabilities. That is, in accordance with the invention, outer shell 103 is adapted to clean or scrub a surface, such as a dish, pot, pan or countertop.

The inventive chainmail sponge 101 is specifically formed for the outer shell 103 to encompass the sponge core 105.

As illustrated, outer shell 103 includes a plurality of interconnected rings 107. Rings 107 may be substantially circular or rounded in shape, squared, oval, or any other suitable shaped. Rings 107 may be interconnected with one another. Alternatively, rings 107 may be adhesively bound to one another at edges, without being interconnected.

Outer shell 103 is formed to abrade, rub, clean, scour or polish a surface, such as a pot or pan.

The rings 107 of outer shell 103 are specifically formed to provide a contoured surface for scrubbing and/or cleaning, while also including multiple edges that contact and lift dirt or debris off of a dirtied surface. The protuberances of the rings 107 provide a series of edges with flexibility for increasing distribution of scrubbing surface area. Additionally, the plurality of rings 107 allows for flexibility and deformation as a result of the pliability between the rings 107, that is, at ring interconnection points 109.

The outer shell 103 may be contoured into a specific shape. Rings 107 may move independently of one another, allowing for closer contact with surfaces, particularly at corners and angles. The outer shell 103 may be formed from metal or plastic, or any other suitable material.

The outer shell 103 may be of any suitable measurement. In one embodiment, the rings are of a diameter between 0.1 and 0.5 inches. Rings 107 may be formed of interlocking or interconnecting rings, and may be of circular, square, rectangular, oval, or any suitable shape.

In one embodiment, such as illustrated in FIG. 1, rings 107 may be interconnected with a plurality of other rings. Thus, rings 107 may be interconnected with two, three, four or more additional rings 107. The rings 107 may be formed in such a way to form any suitable shape for outer shell 103, such as those illustrated in the drawings, including, square, round, oval, heart, rectangle, or any other suitable shape. Additionally, in an embodiment, the rings 107 themselves may be formed of any suitable shape, including square, round, oval, heart, rectangle, or any other suitable shape.

In accordance with the invention, rings 107 may be formed of any gauge or thickness, and outer shell 103 may be formed of any suitable number of rings 107 in any suitable shape. Rings 107 may be independently movable relative to one another to create a contoured working surface.

Rings 107 may be sharpened or edged to create a surface for cutting through dirt. An edged or sharpened ring 107 may be thinned to provide a surface for latching onto dirt or grime and lifting the dirt or grime. The rings 107 may also be formed with non-stick properties, such that no dirt or grime remains attached to them.

In one embodiment, outer shell 103 forms a symmetrical outer shell. Thus, outer shell 103 may be perfectly circular and symmetrical. In an alternative embodiment, outer shell 103 may full enclose or envelop inner sponge core 105.

As illustrated in FIGS. 1 and 3, the outer shell 103 may include a ringed opening 111. Ring opening (also referred to as “central ring”) 111 is shown at a top portion of the chainmail sponge 101. It should be noted, however, that ring opening 111 may be located at any suitable portion within outer shell 103, including on a side or bottom portion.

Ring opening 111 is precisely formed to facilitate movement of sponge core 105 into and out of outer shell 103. This allows the outer shell 103 to encapsulate sponge core 105 and prevent the core 105 from falling out, while also providing for the sponge core 105 to be inserted into, and contained within, outer shell 103.

Ringed opening 111 may include a plurality of rings 107 latched to or interconnected with it. The ringed opening 111 therefore provides for a mechanism for maintaining the shape of chainmail sponge 101.

In one embodiment, sponge core 105 may be removably inserted into outer shell 103, such that it may be removed from shell 103 when desired. That is, sponge core 105 may be removed to replace the sponge due to wear and use, or to replace with a sponge of different material.

In one embodiment, sponge core 105 may be formed to be inserted into outer shell 103, but may not be removable. Thus, outer shell 103 may not be sized to allow removal of the sponge.

In one embodiment, sponge core 105 may be an expandable sponge. For example, sponge core 105 may be package in a compact form, such as a blister pack. The sponge core 105 may be contained within a pill, or within a plastic or gel casing, or may be sufficiently flattened or condensed.

In a further example, the casing may dissolve in liquid. The sponge core 105 may then be inserted into the outer shell 103. Upon coming into contact with liquid, the condensed sponge core 105 may then expand to a full size of the interior of the outer shell 103. In another example, it may take a predetermined amount of time, such as twenty or thirty seconds, for the sponge core 105 to expand upon coming into contact with liquid. In yet a further example, sponge core 105 may be removed and replaced with another condensed sponge core 105.

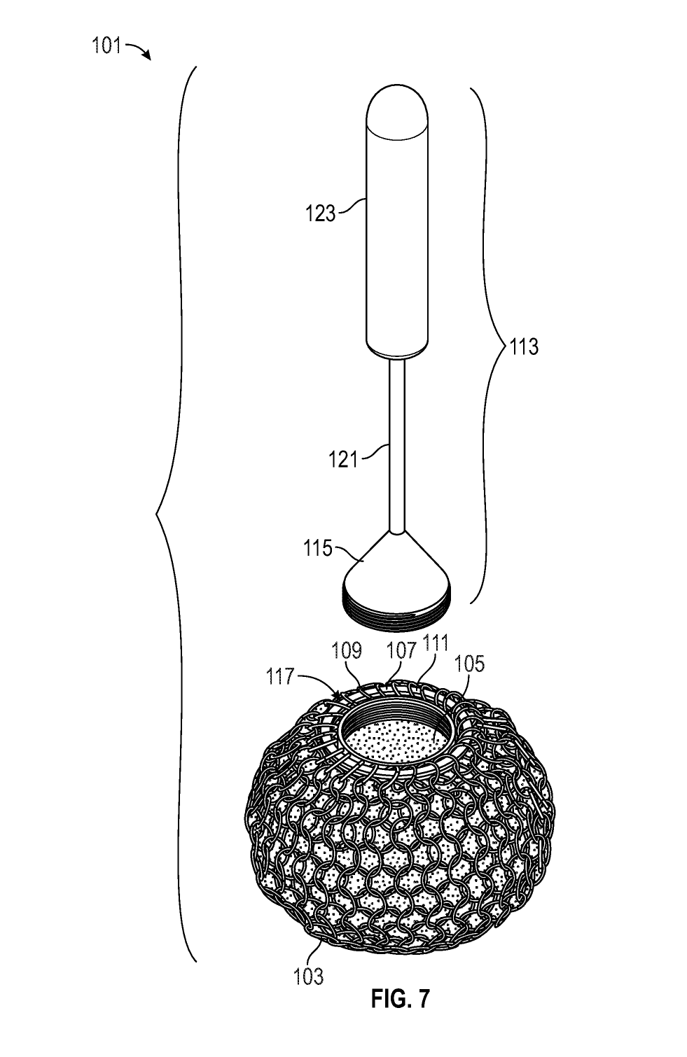

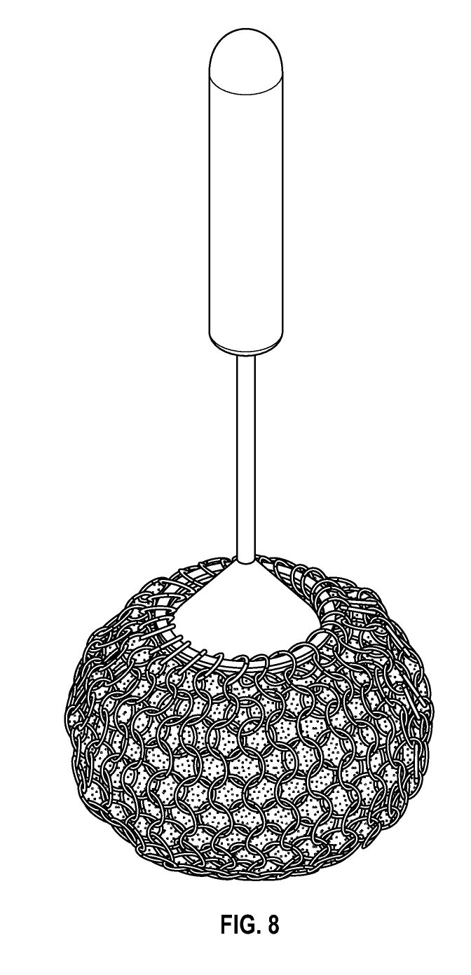

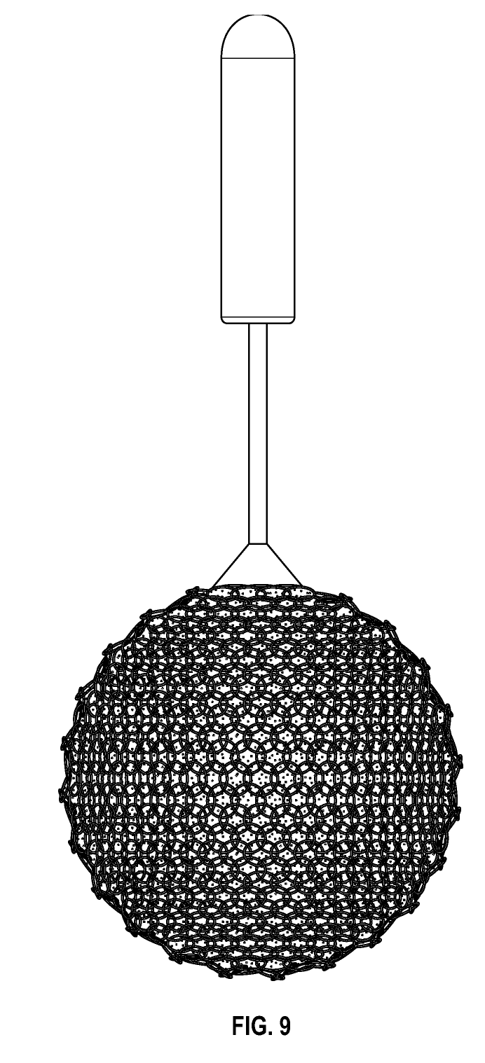

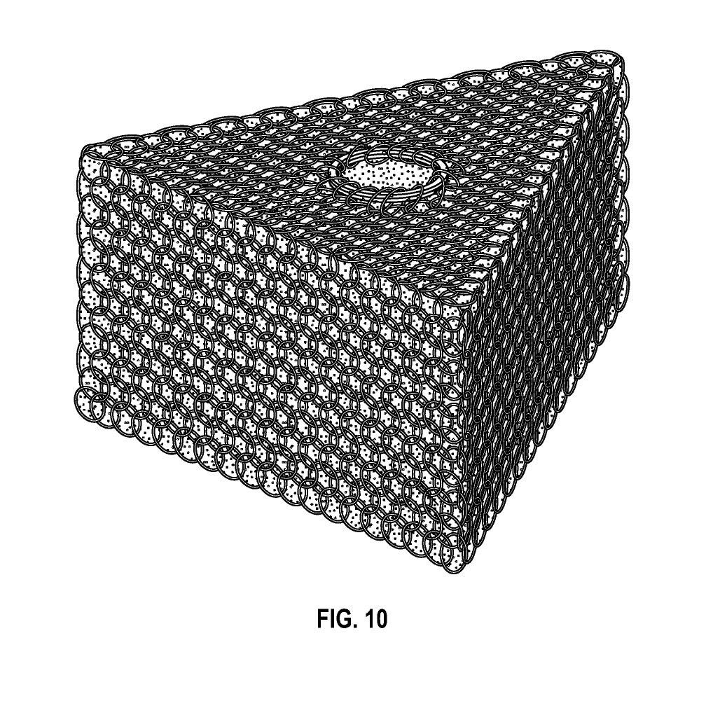

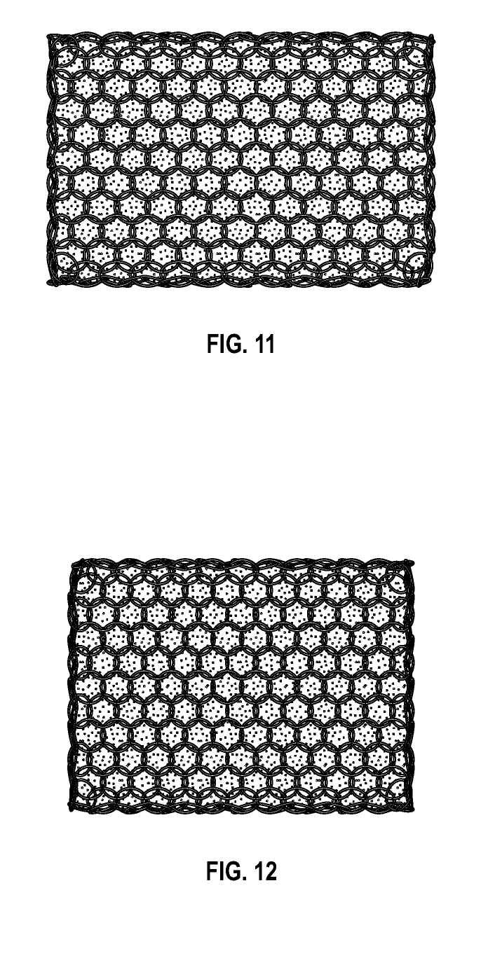

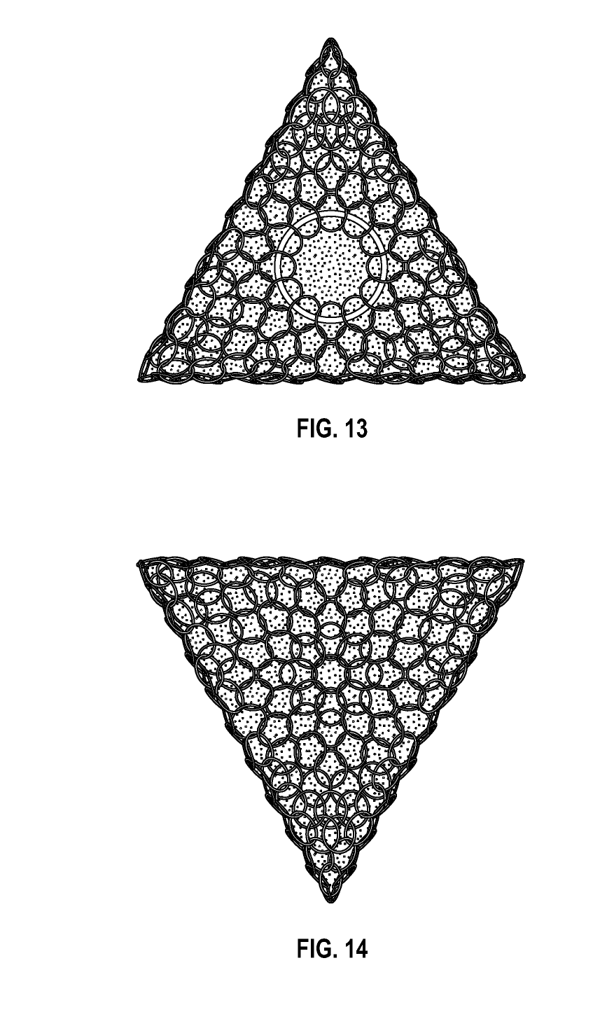

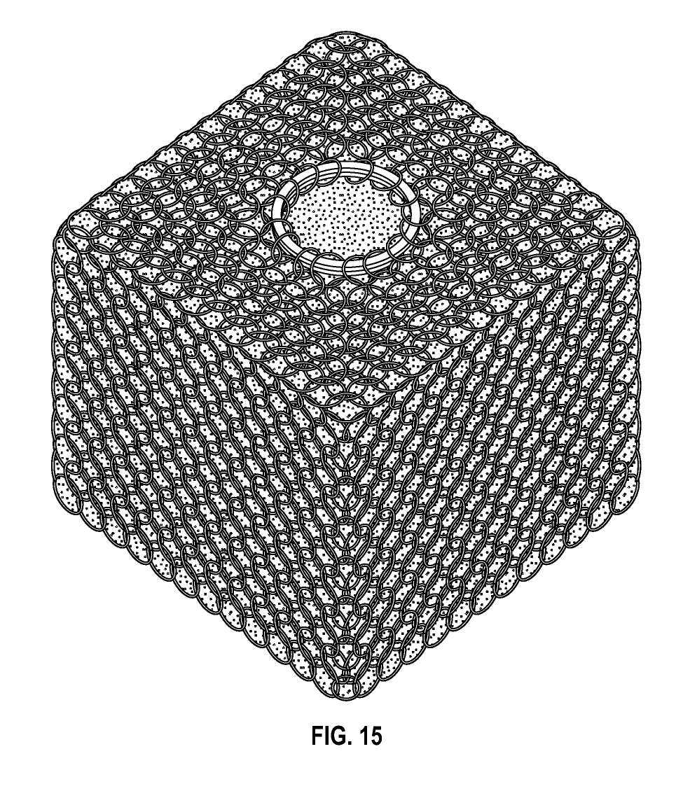

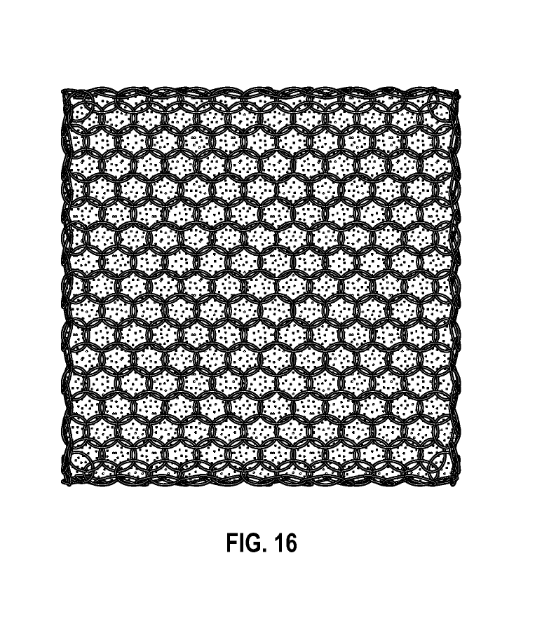

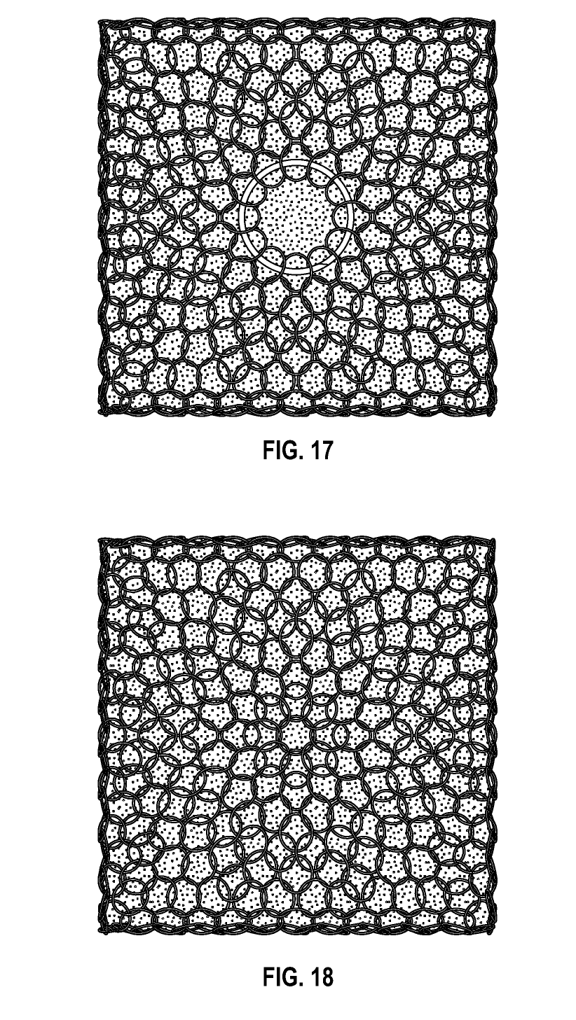

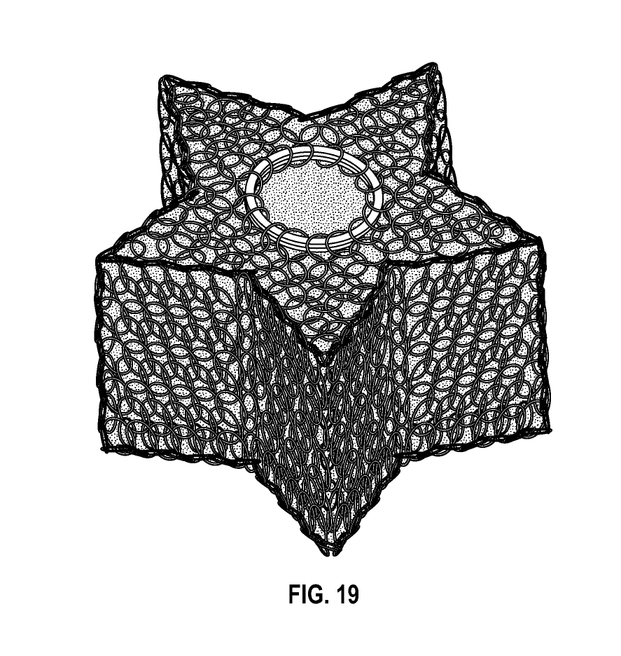

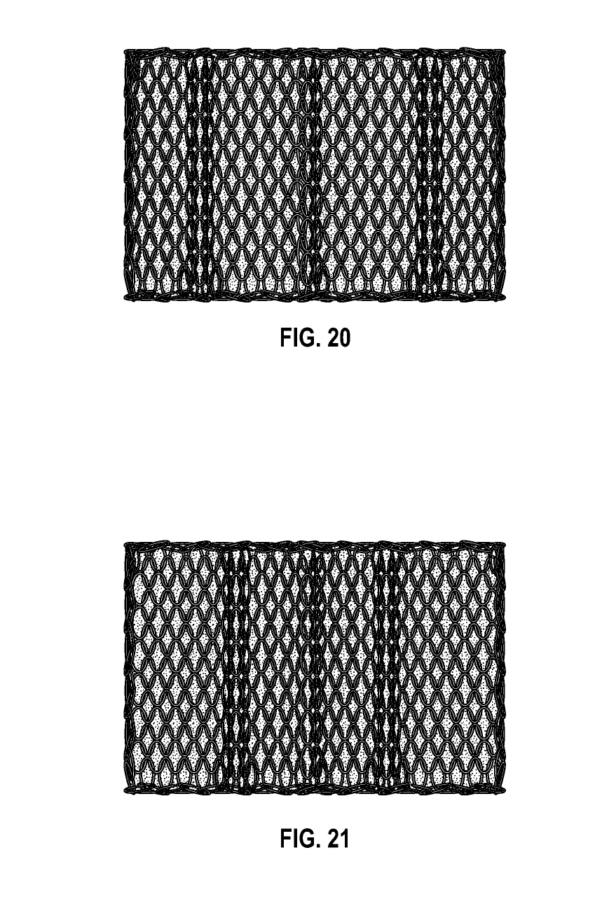

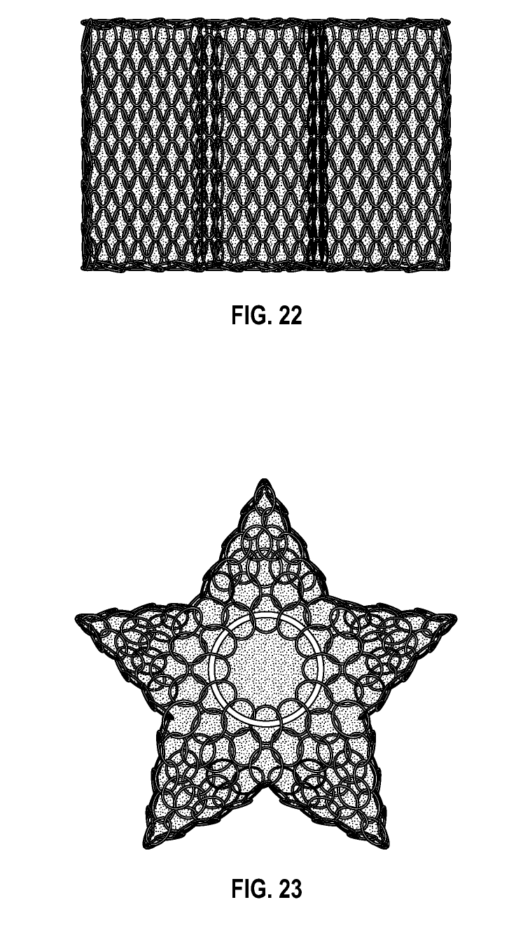

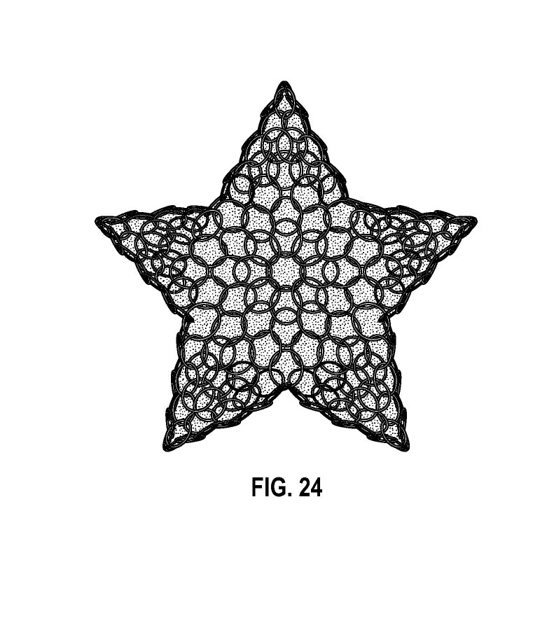

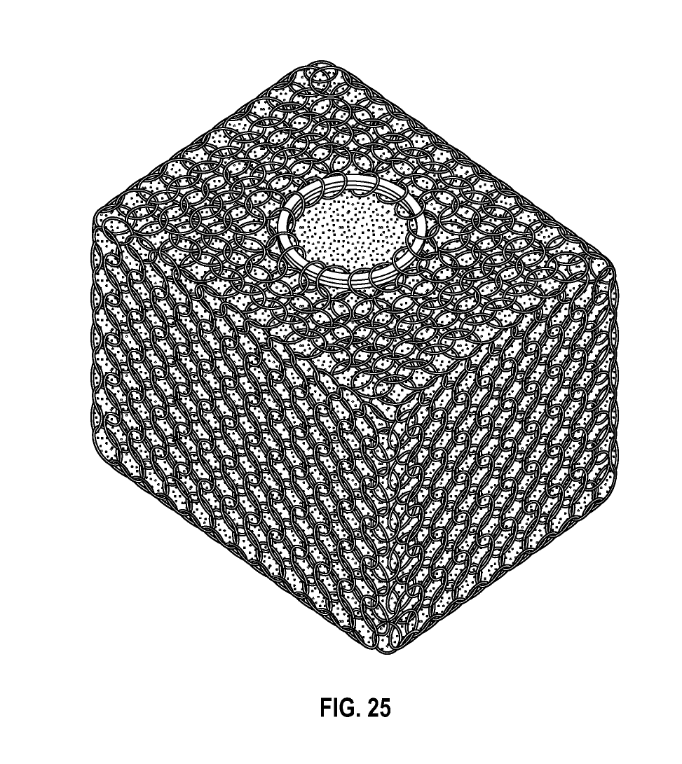

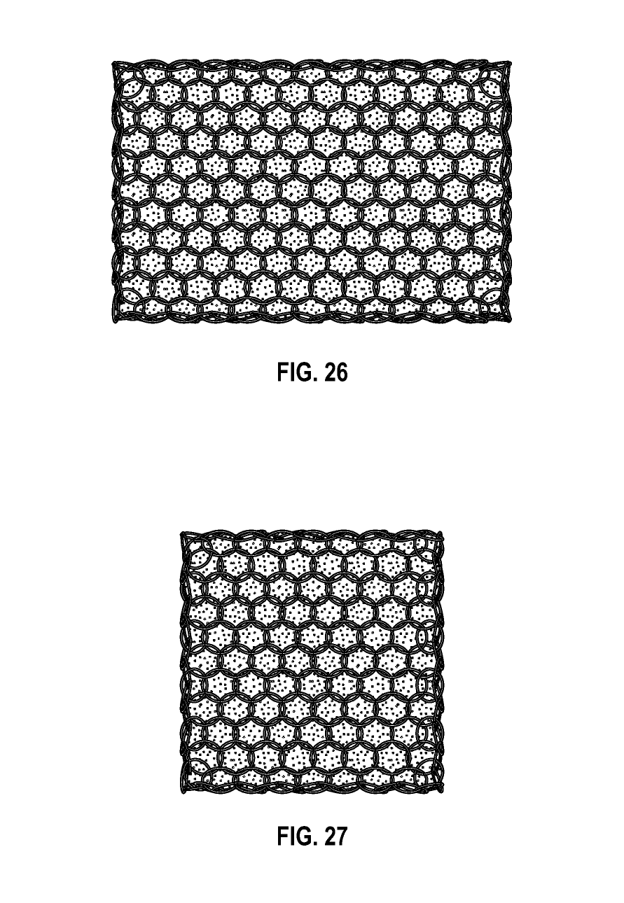

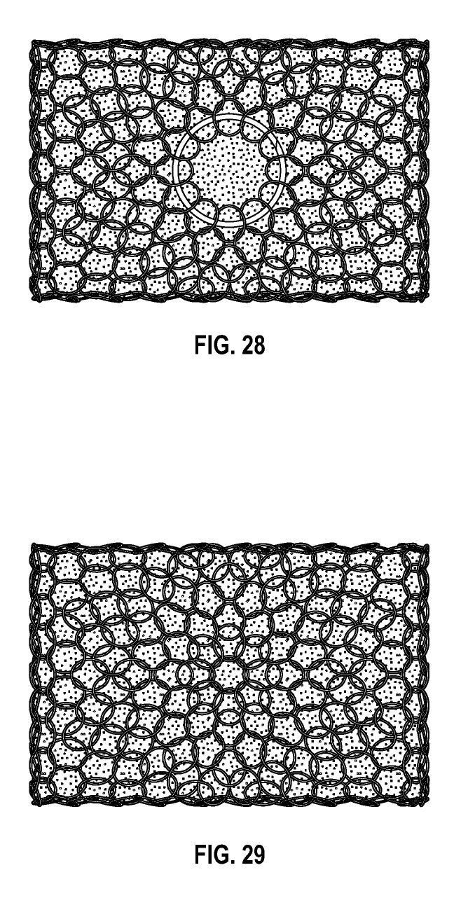

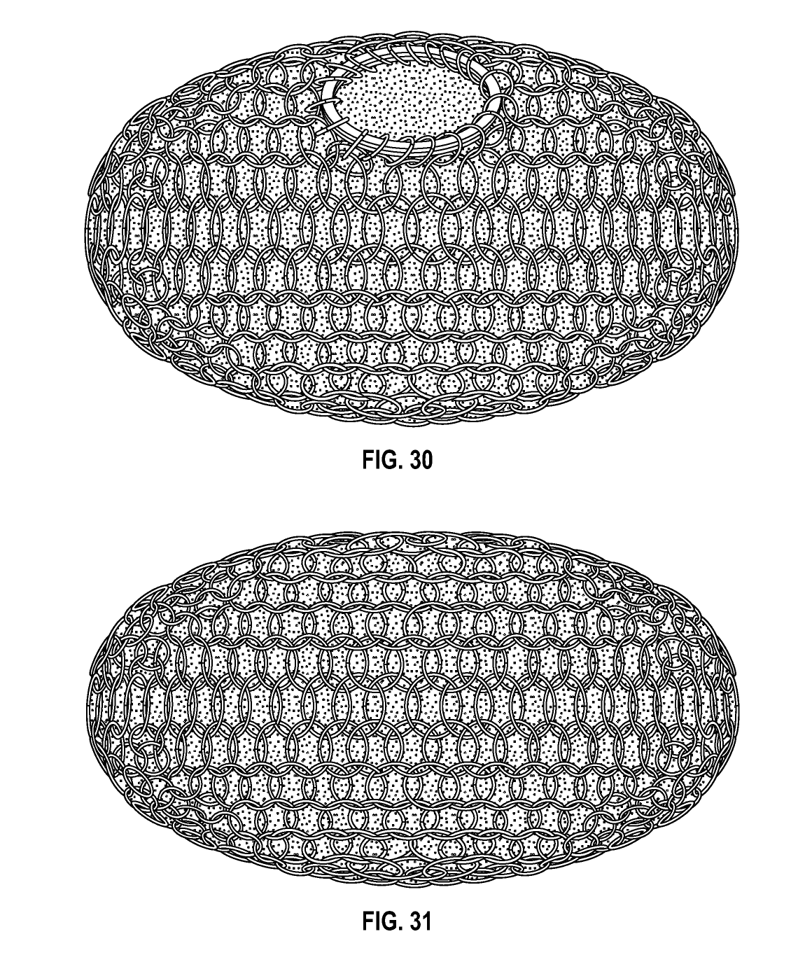

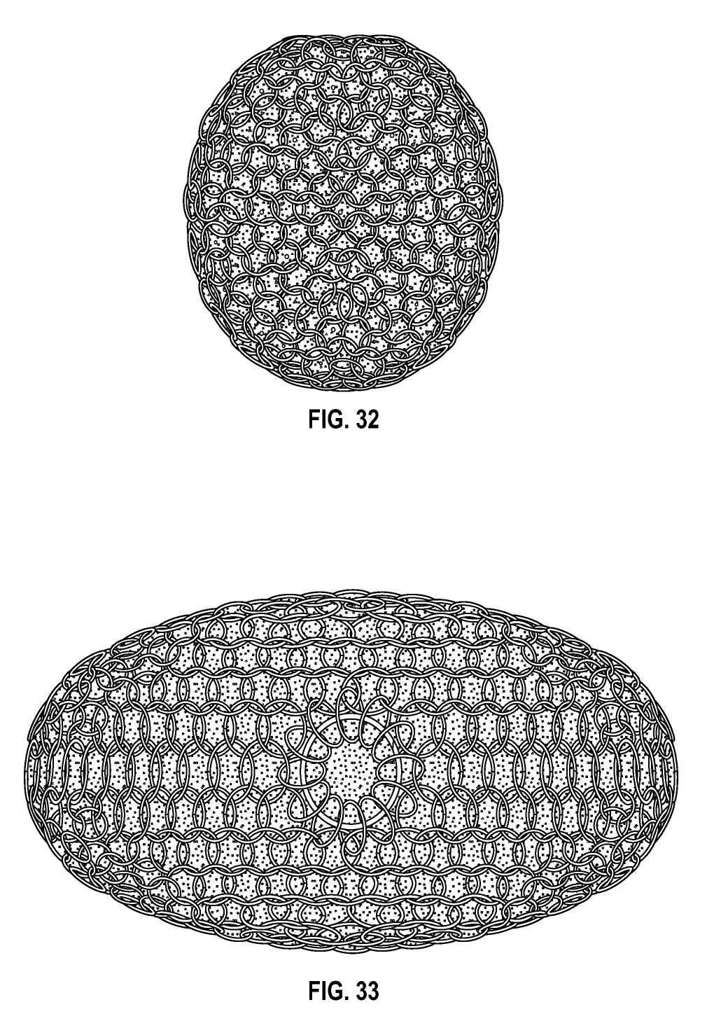

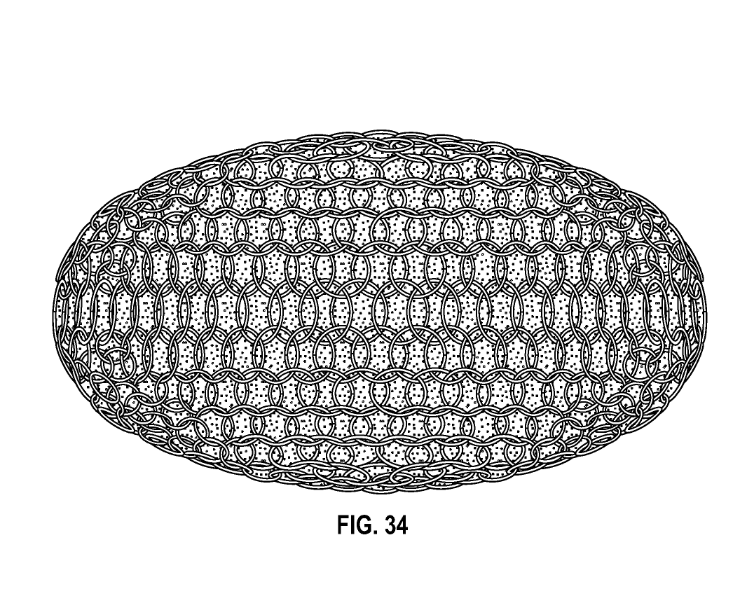

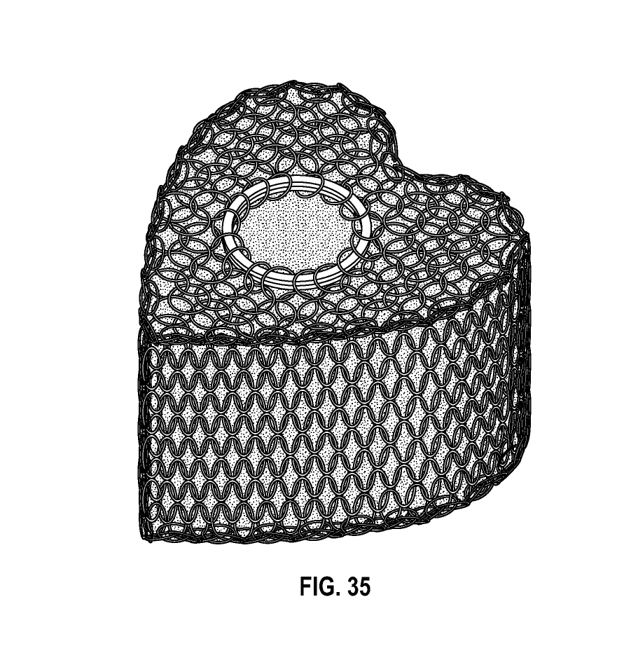

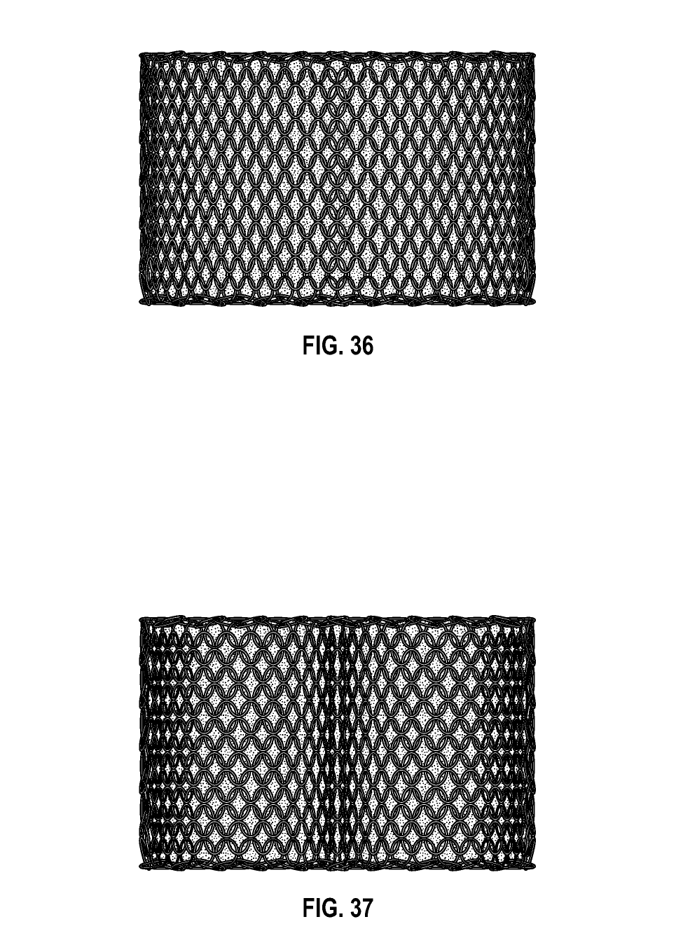

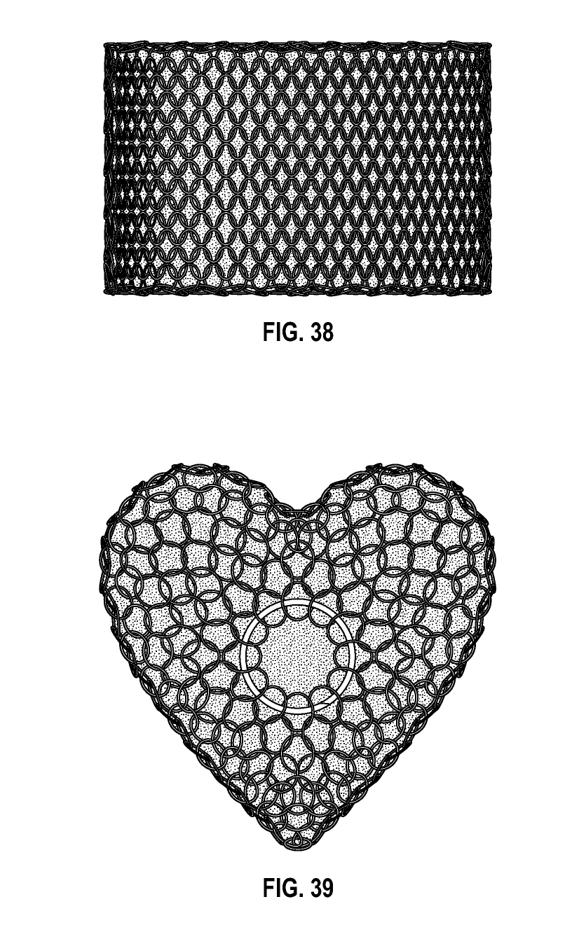

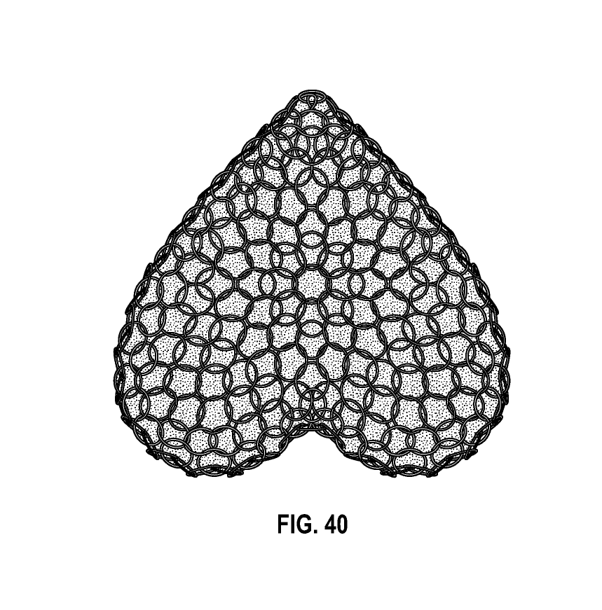

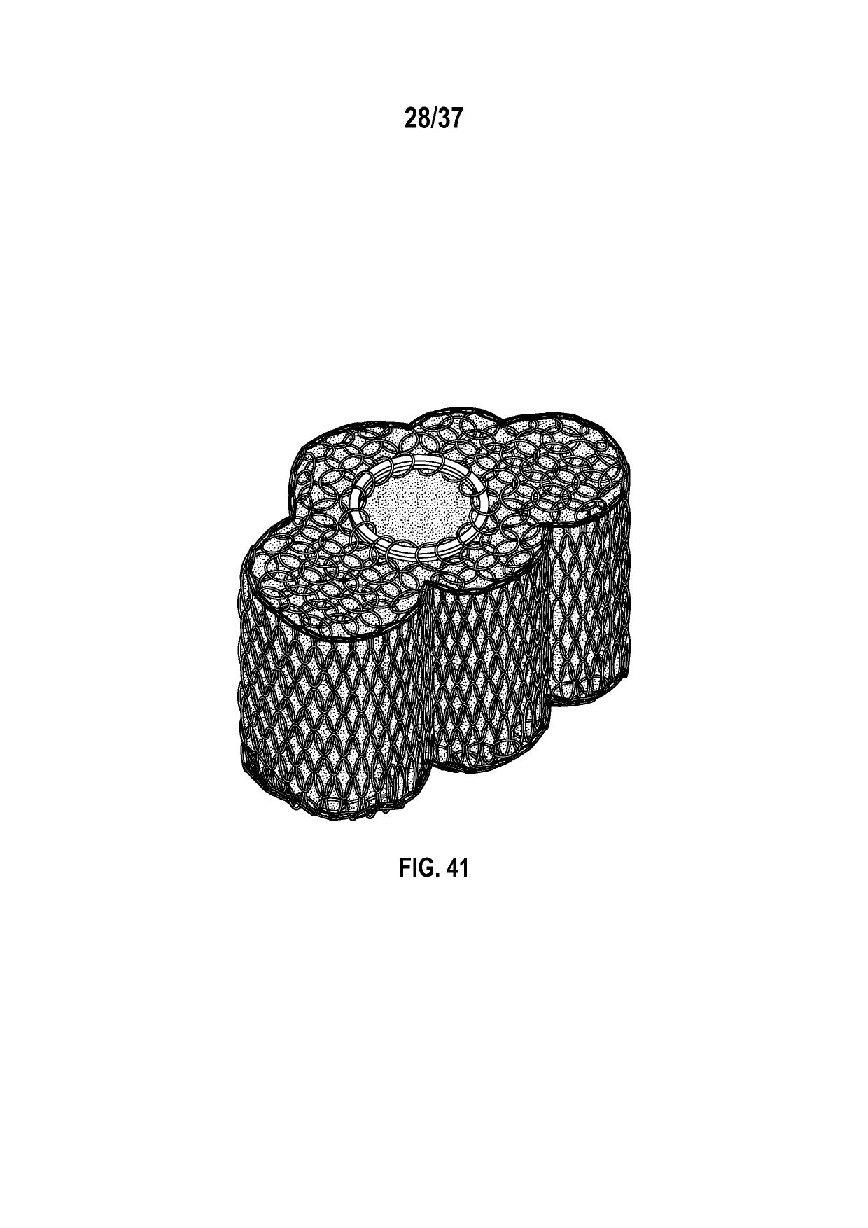

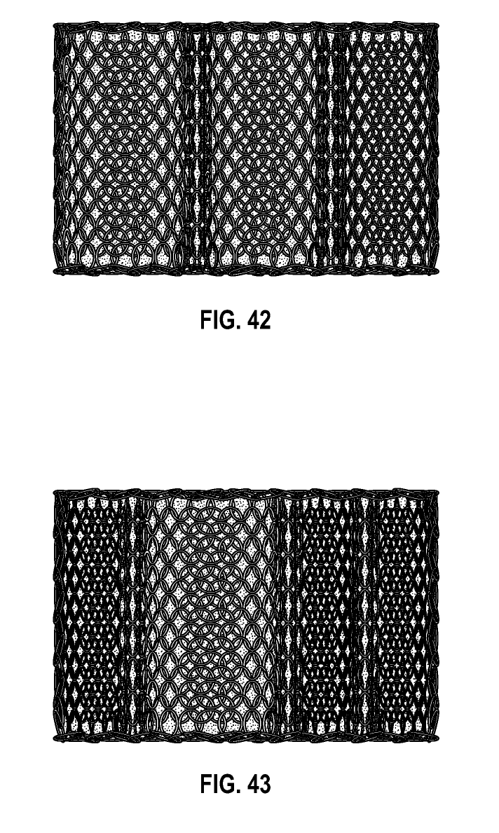

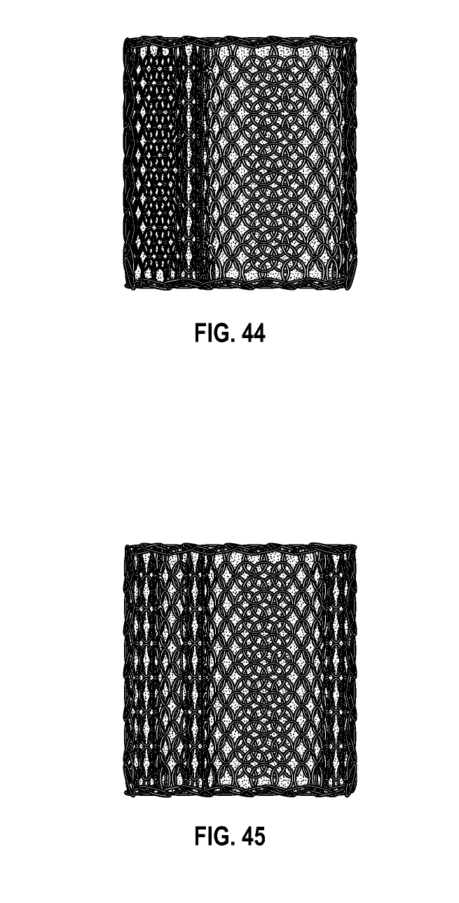

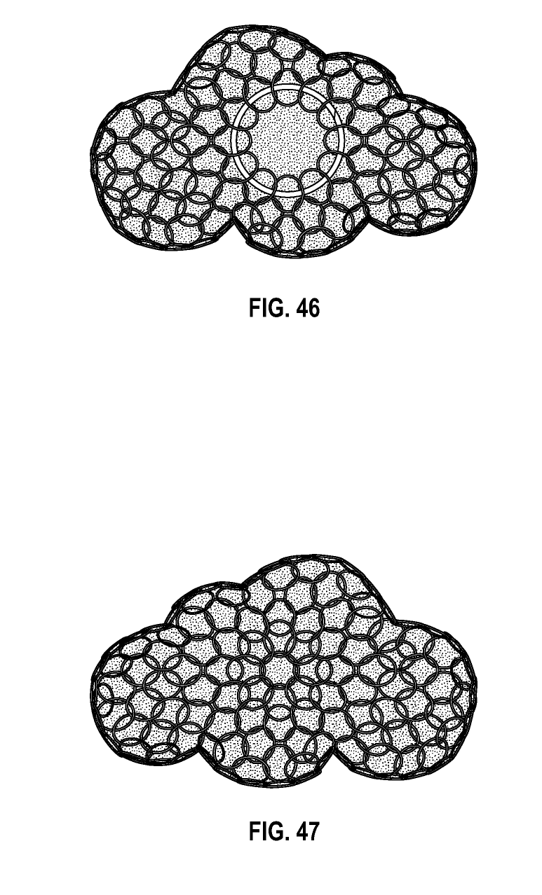

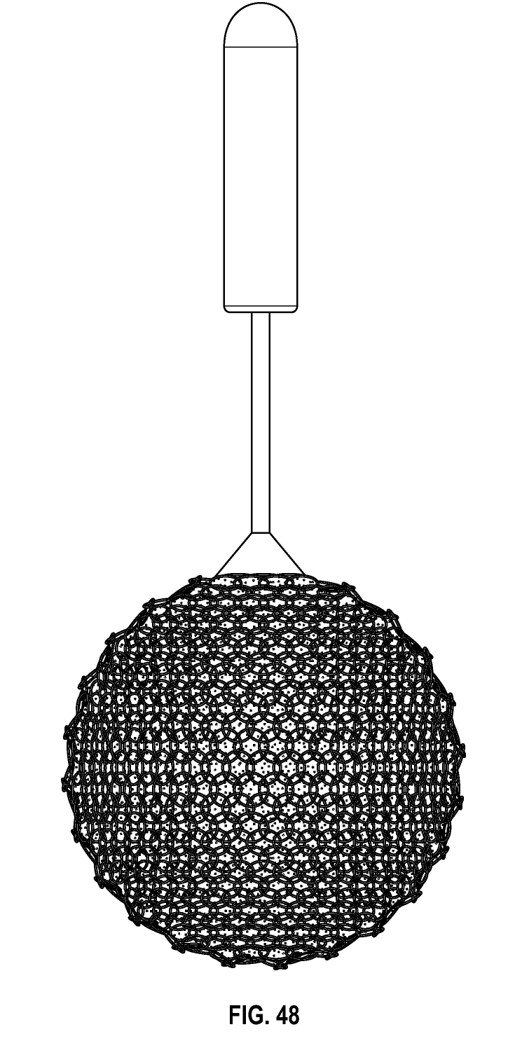

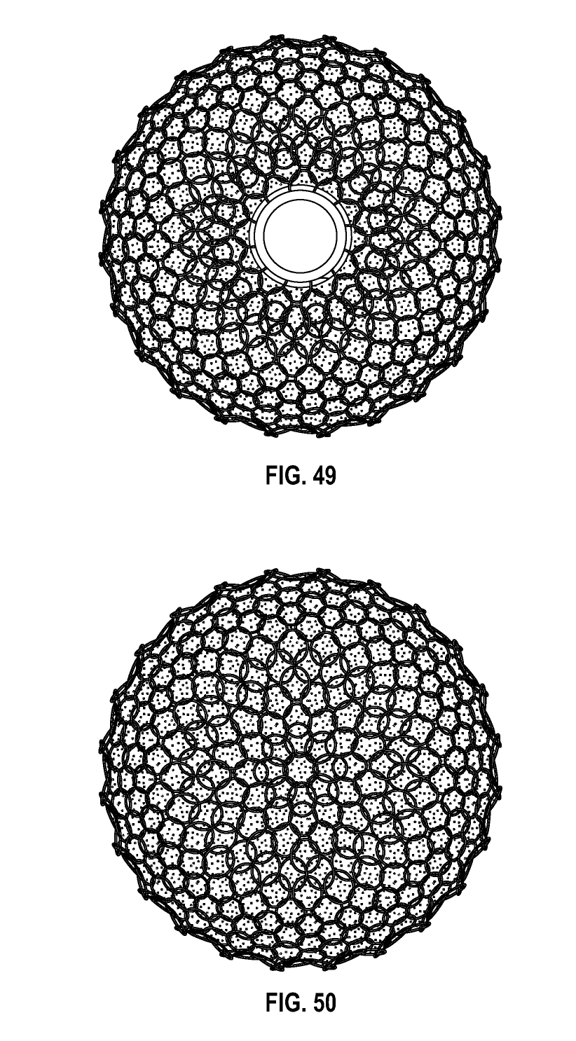

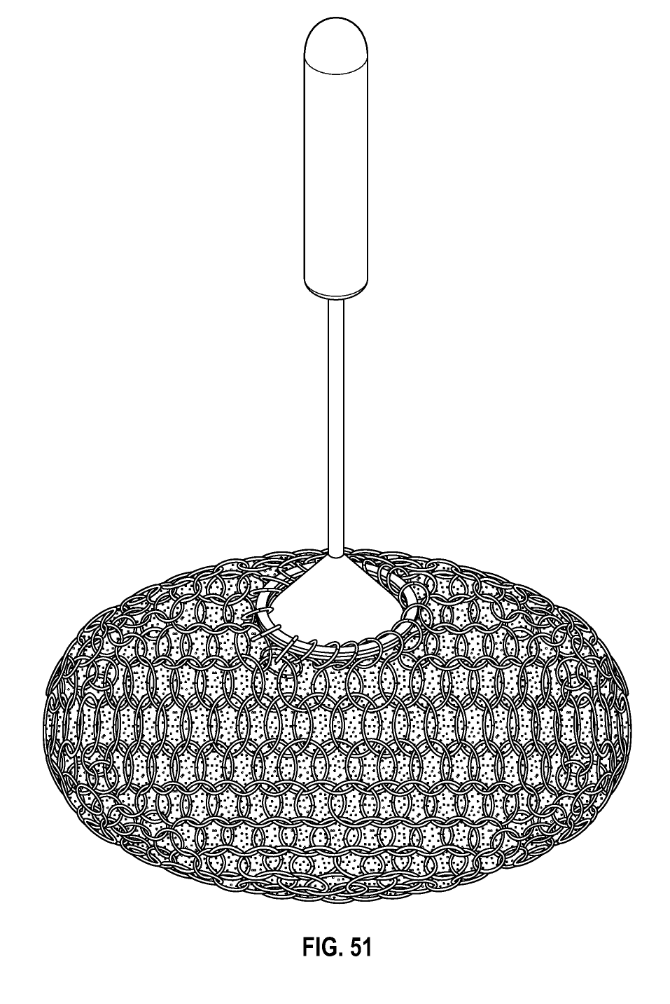

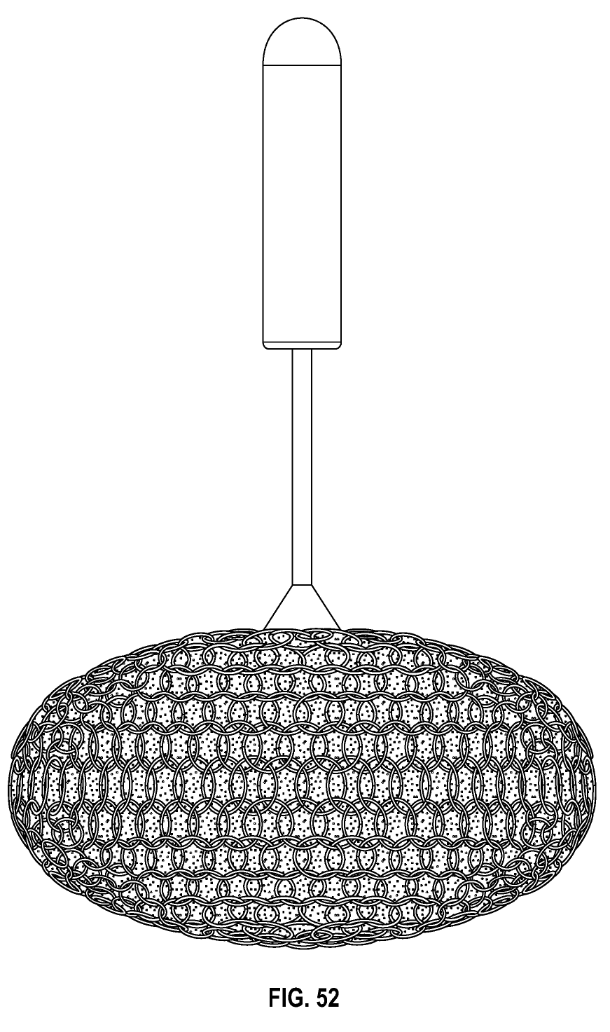

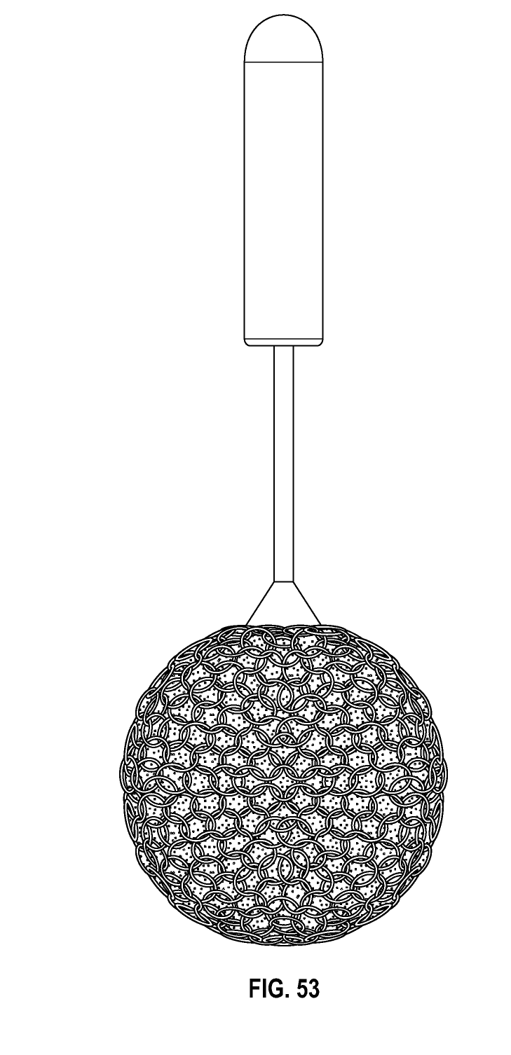

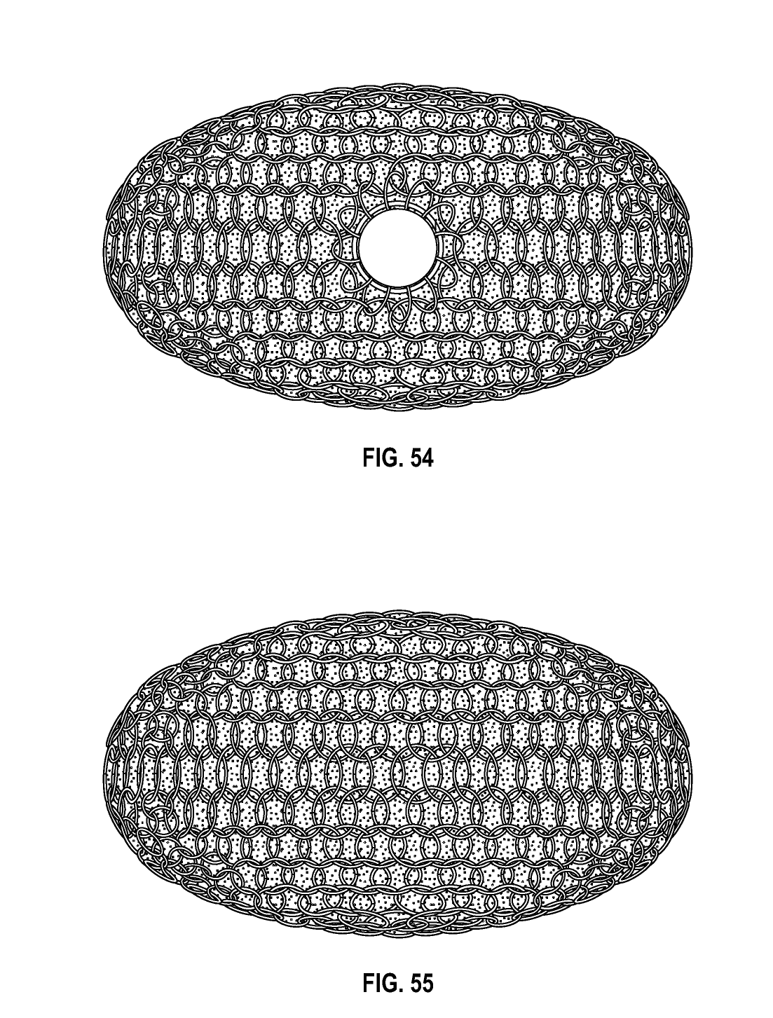

Chainmail sponge 101 may include a handle 113, shown in FIG. 7. Handle 113 provides for holding or grasping the sponge for use on larger items, such as commercial size pots or pans. Handle 113 may be formed from any suitable material, such as molded plastic or metal, or any other suitable material, such as wood. The handle 113 allows for a stronger grasp to be maintained by a user, thereby providing for increased scrubbing and cleaning power with the sponge 101.

Handle 113 may include a mated male-female attachment system. Thus, the handle 113 may include a male fitting or lock 115 at an end, which mates with a female receiver 117 located within the chainmail sponge 101. In an embodiment, the female receiver 117 may be formed within sponge core 105.

In an embodiment of the invention, the female receiver 117 may be continuous, commensurate or interchangeable with ring opening 111. Thus, handle 113, using male fitting 115, may removably attach to chainmail sponge 101 via a female receiver 117 that is formed with ring opening 111.

Handle 113 may include a thin portion 121 and a thick portion 123. Thick portion 123 may be located distal to the chainmail sponge 101, while thin portion 121 may be located proximal and adjacent to sponge 101. Thin portion 121 and thick portion 123 may be formed from uniform or singular construction.

In an embodiment, the sponge may be formed to peak out/stick out through center of rings.

Those skilled in the art will readily recognize numerous adaptations and modifications which can be made to the chainmail sponge of the present invention which will result in improved cleansing methods, yet all of which will fall within the scope and spirit of the present invention as defined in the following claims. Accordingly, the invention is to be limited only by the following claims and their equivalents.

It will be understood that any of the elements described can be rearranged, separated and/or combined without deviation from the scope of the invention. Although the invention herein has been described with reference to particular embodiments, it is to be understood that these embodiments are merely illustrative of the principles and applications of the present invention. It will be apparent to those skilled in the art that various modifications and variations can be made to the present invention without departing from the spirit and scope of the invention. Thus, it is intended that the present invention include modifications and variations that are within the scope of the appended claims and their equivalents.

1. A chainmail sponge comprising:
an outer shell, the outer shell formed of a single layer of chainmail, the chainmail formed of a plurality of interconnected rings;
an inner sponge core, the inner sponge core formed of a sponge material; and
a central ring adapted to insert and remove the inner sponge core,
wherein the inner sponge core is wholly contained within the outer shell.

2. The chainmail sponge of claim 1 further comprising a handle removably connected to the outer shell.

3. The chainmail sponge of claim 2 wherein the handle includes a thinner portion located proximal to the outer shell and a thicker portion located distal to the outer shell.

4. The chainmail sponge of claim 2 wherein the handle includes a male fitting, the sponge further comprising a female receiver.

5. The chainmail sponge of claim 1 wherein the interconnected rings are sharpened.

6. The chainmail sponge of claim 1 wherein the sponge is formed in a substantially rounded shape.

7. A chainmail sponge comprising:
an outer shell, the outer shell formed of a single layer of chainmail, the chainmail formed of a plurality of interconnected rings, wherein the rings are sharpened;
an inner sponge core, the inner sponge core formed of a sponge material;
a central ring adapted to insert and remove the inner sponge core; and
a handle including a male fitting removably connected to the outer shell, the handle include a thick upper portion and a thin lower portion,
wherein the inner sponge core is wholly contained within the outer shell.

8. The chainmail sponge of claim 7 wherein the rings comprise a thickness of 0.1 inches.

9. The chainmail sponge of claim 7 wherein the rings comprise a thickness of 0.3 inches.

10. The chainmail sponge of claim 7, wherein the inner sponge core is formed from cellulose wood fiber.

11. The chainmail sponge of claim 7, wherein the inner sponge core is formed from microfiber.

12. The chainmail sponge of claim 7, wherein the inner sponge core is wholly enveloped by the outer shell.
